(19) United States
(12) Patent Application Publication
(10) Pub. No.: US 2010/0049809 A1
(43) Pub. Date: Feb. 25, 2010

(54) System and method for determining source of an email

(76) Inventor: Jim L. Ladd, Erie, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/229,577

(22) Filed: Aug. 25, 2008

(51) Int. Cl. G06F 15/16; G06F 17/30

(52) U.S. Cl. 709/206; 707/7; 707/E17.009

(57) ABSTRACT

A system and method for determining if a received email is human or machine generated. Each received email is stored temporarily after the sender's address is extracted. A record from a database of challenges is randomly selected. Each record in the database is an image of a commonly known object. Associated with each object is an easily answered question about the object. The answer to the question about the object is also stored with the question. Next a set of image transformations is randomly selected and applied to the randomly retrieved image. The transformed image is sent to the email sender with the challenge (question about the object in the image.) The challenge question is constructed so that answering the challenge is beyond the capabilities of current computing technology. The email is queued until a response to the challenge is received from the sender. When received, the answer provided by the sender is extracted and compared to the answer stored with the randomly retrieved image. If the two answers are the same, the email is moved to the receiver's inbox. Otherwise the email is treated as spam.

### FIELD

The present invention is a client-side computer system and method for determining the source of an Email, whether originated by a human or by a machine. If sent by a machine, the email is blocked or archived, thereby preventing un-wanted emails.

### BACKGROUND

Electronic Mail (email) is an increasingly popular, widely-accepted form of communication. As with traditional postal mail, an individual can receive email of various types from a variety of sources ranging from personal messages from known correspondents to unsolicited “junk” mail from automated mailing sources and even malicious messages containing programmatic content that can destroy a user's computer system (the email equivalent of a letter bomb).

Due to the importance of personal communications, the increasing quantity of junk mailings, and the potential harm of malicious messaging, the need for email filtering schemes is widely recognized. The common goal of email filtering schemes is to deliver to a user only those email messages in which he or she is truly interested. To this end, many methods have been tried, each with some partial success, including filtering by destination, by content, by route taken to delivery, and by sender.

Filtering by destination entails validating the message's delivery address. While a user customarily has one unique email address on a given email system, default settings, software loopholes, and bulk-mailing addresses can sometimes cause generically or imprecisely-addressed messages to be delivered to a user. This type of filtering applies formal rules to verify that the message's destination address is well-formed by internet standards and is, to the extent possible, legitimately intended for the specific user. Destination filtering weeds out blatantly erroneous deliveries, but does nothing to screen out messages sent from unwelcome sources or with unwanted content.

Filtering by content entails scanning the body of a message, or only its header fields (such as its subject line), to identify key textual phrases or attachments of binary file types that might identify the message as unwanted. The advantage of this approach is that it adheres closely to the spirit of email filtering: the identification and removal of unwanted messages. Unfortunately, the variety and number of key phrases which can act as potential triggers for filtering is so enormous that no system can legitimately hope to be complete, and the time required to conduct such screening is almost certainly prohibitive. In identifying unwanted binary attachments, such a filter is usually dependent on a degree of self-disclosure on the part of the sender ascertain the binary format being used and thereby assessing the degree of such attachments may pose. In recent years, seemingly passive graphic formats have been altered by malicious programmers to contain harmful executable code.

Filtering by route taken to delivery relies on the content of a message's headers which contain “bread crumbs” identifying the internet sites through which the message has passed in order to reach its destination. Addresses can then be compared to a database containing a blacklist of servers known to have been involved in harmful activities in the past. The advantage of this scheme is that it can stop high-volume “denial of service” attacks before they become widespread. The greatest disadvantage is that “innocent” intermediary servers become blacklisted by implication, causing subsequent valid emails to be discarded.

Filtering by sender is a fruitful arena in which new filtering schemes are still being discovered. The simpler forms entail comparing the sender's return address to a blacklist or a whitelist and (respectively) rejecting or accepting the message on that basis. Clever, or outright malicious, senders have long ago learned to fake return addresses, so this form of sender filtering is largely outmoded. A more sophisticated class of sender-filtering schemes involves identifying the sender by characteristics, such as individual vs. organization, domestic vs. international, human vs. automaton.

An individual email message often contains too little information to allow assessment of the sender's desirable key characteristics (“individual+human”, for example). One way of obtaining more data is to issue a challenge message to the sender requiring a response which reveals additional information about the sender. Failure to receive a response indicates that the return address was invalid or that the sender (regardless of other traits) does not consider the original message important enough to be worthy of a second delivery attempt. An inappropriate response confirms that the message originated from an unwanted source. In this way, sender filtering can be fine-tuned to suit individual cases.

Generating effective challenge messages requires a combination of creativity and rigorous logic that most email users find prohibitively labor-intensive. Challenge systems are more likely to be widely adopted when they can be automated to the greatest extent possible.

Problems lie in degree to which an undesirable sender, such as an automaton, can be programmed to generate a misleading reply. For example, a challenge that issues a textual phrase and demands a textual response can be fooled by an automated system that recognizes key phrases, permutes them according to well-known linguistic rules, and returns a plausable response. Similarly, a graphic rendition of typable characters can be decoded by an optical character recognition (OCR) device and returned to the challenger in clear text.

### Objects

The present invention provides a method of differentiating between human and automated senders by issuing challenges that thwart many of the known automated response mechanisms available to malicious senders.

By avoiding the use of typable characters (in either textual or graphical format), the invention precludes the use of OCR-automated response mechanisms.

By carefully avoiding the use of key phrases that might alert the respondent to the content of the challenge, the invention precludes the use of automated textual manipulation tools in formulating the challenge response.

By sending graphical information or images, and challenges that relate to properties and relationships among elements of the graphical information or images, the system and method of the invention precludes the use of programs that may interpret and “understand” the challenge presented.

By performing graphical manipulations, the invention effectively guarantees that no two challenges are identical, so an automated respondent cannot rely on a database of past challenges to provide clues to construction of its response.

By implementing the system and method of the invention on the user's client, the system and method ensures quick and simple implementation and significantly less vulnerability to hacking.

Other benefits and advantages of the invention will appear from the disclosure to follow. In the disclosure reference is made to the accompanying drawings, which form a part hereof and in which is shown by way of illustration specific embodiments in which the invention may be practiced. These embodiments will be described in sufficient detail to enable those skilled in the art to practice the invention, and it is to be understood that other embodiments may be utilized and that structural changes may be made in details of the embodiments without departing from the scope of the invention.

### SUMMARY

The invention, disclosed in an exemplary embodiment, is a client-side system and method to challenge an unknown sender of an email message to validate that the sender is a human, not a machine. For example, when an email is received from an unknown sender, a reply message is automatically sent to the sender's email address. The reply contains a challenge that only a human can satisfy. If the challenge is successfully met and returned in a timely fashion, the original email is approved and may be viewed by the recipient.

The challenge in the reply message goes beyond the typical alphanumeric challenges. The challenges are graphical or photographical images that are transformed in different ways. The types and degree of transformation make the graphical images difficult to recognize by automated programs but the final image is still easily recognizable by humans.

Further, the challenge may comprise questions about the semantics (meanings) of relationships among graphical elements, that beyond the capability of current computing technology.

The types of transformations include but are not limited to:
1. Resizing in both X & Y dimensions (both proportional and non-proportional)
2. Rotating
3. Shearing in both X & Y dimensions
4. Background and foreground color transformations
5. Blurring
6. Shadowing
7. Noise filtering

Another key concept is that the program is a client-side application that relies on no external servers or host computers.

Further detail and description are found in the following narrative and drawings that are part of this disclosure.

### BRIEF DESCRIPTION OF THE DRAWINGS

FIG. 1 illustrates a typical processing environment for practicing the invention.

FIG. 2 is a logic diagram of an algorithm used in the exemplary embodiment of the invention.

FIG. 3 depicts a transformation of the algorithm illustrated in FIG. 2.

### DETAILED DESCRIPTION

### An Exemplary Embodiment

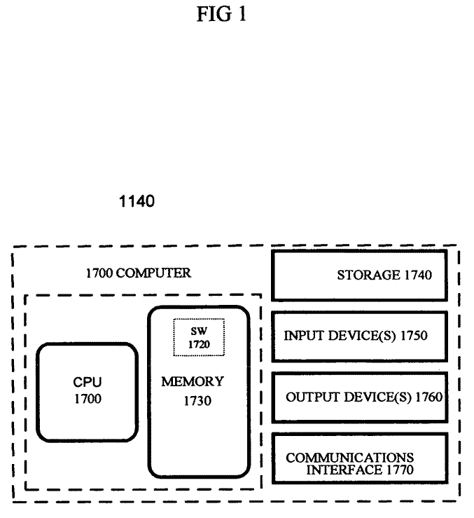

In the exemplary embodiment that follows, a computing environment is required for processing emails and for issuing a challenge to the sender to determine the source of the email. This computing environment is illustrated in FIG. 1.

With reference to FIG. 1, processing of emails and issuing challenges to email senders may be implemented; for example, within a client computing environment 1140, which includes at least one processing unit 1700 and memory 1730. In FIG. 1, this most basic configuration 1140 is included within a dashed line. The processing unit 1700 executes computer-executable instructions and may be a real or a virtual processor. In a multi-processing system, multiple processing units execute computer-executable instructions to increase processing power. The memory 1730 may be volatile memory (e.g., registers, cache, RAM), non-volatile memory (e.g., ROM, EEPROM, flash memory, etc.), or some combination of the two. The memory 1730 stores executable software—instructions and data 1720—written and operative to execute and implement the software applications required for an interactive environment supporting practice of the invention.

The computing environment may have additional features. For example, the computing environment 1140 includes storage 1740, one or more input devices 1750, one or more output devices 1760, and one or more communication connections or interfaces 1770. An interconnection mechanism (not shown) such as a bus, controller, or network interconnects the components of the computing environment, for example communicating with email servers and computers of email senders. Typically, operating system software (not shown) provides an operating environment for other software executing in the computing environment, and coordinates activities of the components of the computing environment.

The storage 1740 may be removable or non-removable, and includes magnetic disks, CD-ROMs, DVDs, or any other medium which can be used to store information and which can be accessed within the computing environment. For example, the storage may store credit or debit balances, limits, and past transactions. The storage 1740 also stores instructions for the software 1720, and is configured, for example, to store images for transformation and sending to email senders, and to store transformation algorithms for transforming images to challenge email senders.

The input device(s) 1750 may be a touch input device such as a keyboard, mouse, pen, or trackball, a voice input device, a scanning device, or another device that provides input to the computing environment. For audio or video, the input device(s) may be a sound card, video card, TV tuner card, or similar device that accepts audio or video input in analog or digital form. The output device(s) 1760 may be a display, printer, speaker, or another device that provides output from the computing environment.

The communication interface 1770 enable the operating system and software applications to exchange messages over a communication medium with other computers and devices in various instantiations of the practice of the invention. The communication medium conveys information such as computer-executable instructions, and data in a modulated data signal. A modulated data signal is a signal that has one or more of its characteristics set or changed in such a manner as to encode information in the signal. By way of example, and not limitation, the communication media include wired or wireless techniques implemented with an electrical, optical, RF, infrared, acoustic, or other carrier.

The communications interface 1770 is used to communicate with other devices such as email servers and computers of email senders. For example, the interface 1770 may be attached to a network, such as the Internet, whereby the computing environment 1140 interchanges command, control and feedback signals with other computers, and devices.

### Image Transformations

A two-dimensional digital image may be represented by a two-dimensional array of (floating-point) numbers, each of which represents a pixel in the image. In this form of an array, the image array is subject to transformation by a matrix. In the following, transformation by matrix is described. This description is not meant to limit the manner by which images are transformed, but is merely illustrative as one means for transforming images to send to a email source.

A matrix is a rectangular table of elements (or entries), which may be numbers or, more generally, any abstract quantities that can be added and multiplied. Matrices are used to describe linear equations, keep track of the coefficients of linear transformations and to record data that depend on multiple parameters.

Matrices may represent linear transformations between finite-dimensional vector spaces. Let Rⁿ be an n-dimensional vector space, and let the vectors in this space be represented in matrix format as column vectors (n-by-1 matrices). For every linear map ƒ: Rⁿ→R^{m} there exists a unique m-by-n matrix A such that

ƒ(x)=Ax

for each vector x in Rⁿ.

In the notation above the matrix A “represents” the linear map ƒ, or that A is the “transformation matrix” of ƒ. In the notation above, the function ƒ is a function of the position in the array of pixels; the value (range) of the function is the pixel value.

It is well known in the theory of linear algebra that matrices may be constructed to rotate, and shear images. Similarly, matrices may be used to transform the values of pixels, which may represent the color value of an image element.

Further a matrix may be constructed to represent noise and this matrix may be added to an array of pixel values.

In addition matrices may be constructed to transform pixels as linear or even non linear transformations of combinations of other pixels. In this way an image may be smeared or warped.

### An Exemplary Algorithm

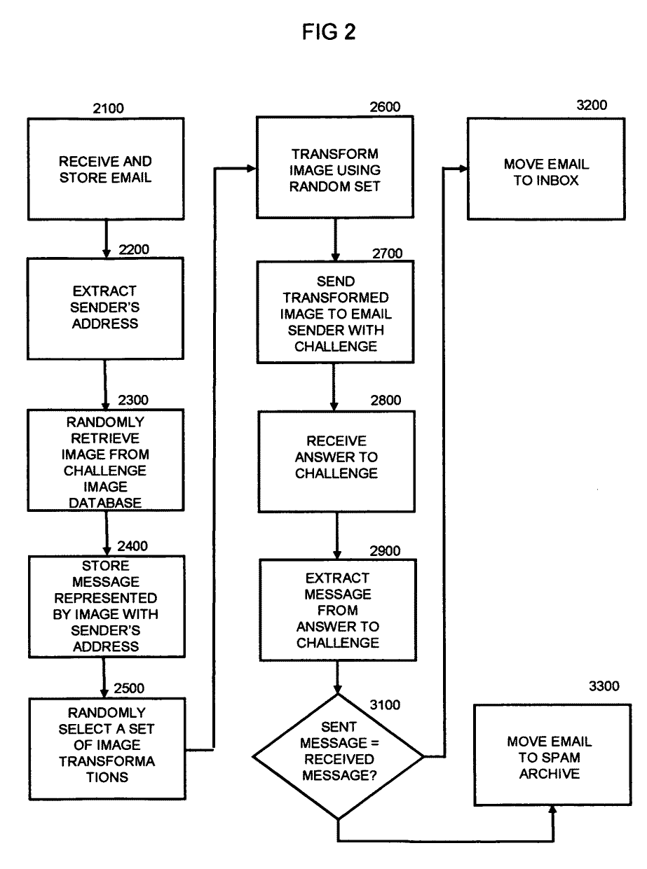

FIG. 2 illustrates an algorithm that may be used in the practiced of the invention. The algorithm is described as one example of the invention and should not be construed as a limitation of the inventive concept of the invention. All of the following disclosure is made with reference to FIG. 2.

In step 2100 an email is received in the client system. The email is stored in a temporary file. The source of the email is not known—it may be a person or generated by a machine. The system and method of the invention will now issue a challenge to the sender to determine the source of the email.

In step 2200 the IP address (or equivalent) is extracted from the email. This address will be the receiver of the challenge to the email.

In step 2300, a database is accessed randomly to retrieve an image as a rendering of a well-known object

In step 2400 the text message associated with the image is extracted from the database record accessed. In this case, the text message is a brief description of the object in the image or a simple question and the answer about the image.

In step 2500, the answer to the question associated with the image is stored with the IP address of the email sender.

In step 2600, a random set of transformations are selected. The set is applied to the image.

In step 2700, the transformed image is transmitted with the challenge to the sender.

In step 2800, the system and method receives the sender's message response to the challenge.

In step 2900, the answer to the challenge question is extracted from the sender's answer.

In step 3100, the answer is extracted from the sender's reply is compared to the answer associated with the transformed image.

In step 3200, if the two messages are the same, the email message is moved to the inbox.

In step 3300, if the messages are not the same, the email is treated as spam.

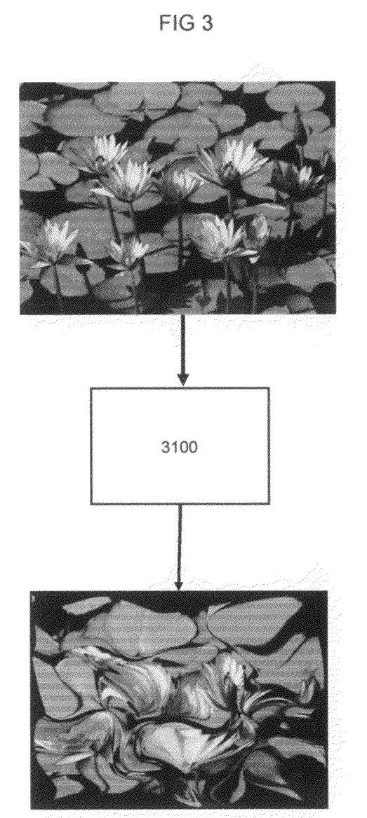

FIG. 3 illustrates the effects of the transformation algorithm illustrated in FIG. 2 and disclosed above. FIG. 3 is merely illustrative and should not be construed as a limitation to the invention.

In FIG. 3, an image of flowers (water lilies) is randomly selected from the database. The name of the image (for example, “flowers”) is accessed and stored as the answer to the challenge. The image is transformed. The transformed image and a challenge (such as “name the object”) is sent to the sender of the email.

As in the algorithm disclosed above, the sender answers the question and submits the answer. If the sender answers “flowers” or “lilies”, the email is sent to the receivers in-box. Otherwise, the email is treated as spam.

In addition, the challenge may require the sender to answer questions that require the application of semantic knowledge. For example, a possible challenge related to FIG. 3 is the question “what are the colors of the flowers in the image?” Or the challenge question could be “what is common to the flower petals in the image?”

### DISCLOSURE SUMMARY

The present invention has been taught from an exemplary embodiment, which may be modified or altered according to the claims, which follow.

What is claimed is:

1. A method in a client side computer system for determining the source of an email message is a person or a machine, the method comprising:
receiving an email message;
storing the email message in a temporary queue;
randomly retrieving a record from a database, the record comprising an image of an object, a question about the object, and the answer to the question;
randomly selecting a set of image transformations for the image;
transforming the image,
sending the transformed image and the question to the sender of the email;
challenging the sender to answer the question;
receiving the answer to the challenge from the sender of the email, and;
removing the email message from the queue and processing the email based upon the accuracy of the answer to the challenge.

2. The method of claim 1, further including placing the email in the receiver's email queue if the email sender's answer is correct.

3. The method of claim 1, further including the step of disposing the email if the email sender's answer is wrong.

4. A client-side computer method for releasing an email message from a queue, the method comprising:
identifying the address of the email sender;
retrieving an image of an object;
retrieving a question about the object;
retrieving an answer to the retrieved question;
transforming the image;
creating a challenge to the sender of the email, the challenge comprising the transformed image, and the retrieved question;
sending the challenge to the email sender;
receiving a response from the email sender;
comparing the response to the retrieved answer, and;
releasing the email message from the queue based upon the comparison.

5. The method of claim 4, wherein the email is released to the email recipient's in-box if the comparison is positive.

6. The method of claim 4, wherein the email is discarded if the comparison is negative.

7. The method of claim 4, wherein the challenge consists of a question about the transformed image, the question requiring semantic processing by the sender of the email.
